(19) United States
(12) Patent Application Publication
(10) Pub. No.: US 2026/0328177 A1
(43) Pub. Date: Oct. 22, 2026

(54) GREEN AND ENVIRONMENTALLY FRIENDLY LOW-CONSUMPTION POWER MACHINE

(71) Applicant: Ni Zheng Chao, Honolulu, HI (US)

(72) Inventor: Ni Zheng Chao, Honolulu, HI (US)

(21) Appl. No.: 19/181,465

(22) Filed: Apr. 17, 2025

(51) Int. Cl. F03B 17/00; F03B 11/00; F03B 13/06

(52) U.S. Cl. CPC F03B 17/005; F03B 11/008; F03B 13/06

(57) ABSTRACT

An environmentally friendly low-consumption power machine comprises a primary water-air pressure tank connected to an outlet pipe, which may be fluidly connected to an impeller. An adjustable size outlet valve may be positioned between the outlet pipe and the impeller. A secondary water-air pressure tank may be included. Backwater pipes may be connected between the impeller and the primary water-air pressure tank. The primary water-air pressure tank may contain a mixture of water and pressurized air. The adjustable size outlet valve may control a water flow rate to the impeller. The secondary water-air pressure tank may regulate system pressure. The backwater pipes may recirculate water from the impeller back to the primary water-air pressure tank. A sealing mechanism may be provided for the primary water-air pressure tank. An air pressurization system may add pressurized air to the primary water-air pressure tank. Power generation equipment may be coupled to the impeller.

### FIELD OF THE INVENTION

The present disclosure generally relates to power generation systems, and more particularly to a green and environmentally friendly low-consumption power machine utilizing water and air pressure in a closed system to generate power.

### BACKGROUND

Power generation systems that are environmentally friendly and consume low amounts of resources are desirable in many applications. Conventional power generation methods often rely on non-renewable resources or produce significant environmental impacts. There is a need for improved power generation systems that are sustainable, efficient, and have minimal environmental impact.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF SUMMARY

The present disclosure provides a green and environmentally friendly low-consumption power machine. In one aspect, the power machine includes a primary water-air pressure tank, an outlet pipe connected to the primary tank, an impeller driven by water flow from the outlet pipe, an adjustable size outlet valve controlling water flow to the impeller, a secondary water-air pressure tank, and backwater pipes for water recirculation. In some embodiments, the power machine operates by adding water to the primary water-air pressure tank, connecting it to the backwater pipes to stop water outflow, sealing the tank, and then adding air pressure. This creates high pressure flow through the pipeline to drive the impeller rotation at high speed. These and other features of the present disclosure will become more fully apparent from the following description and appended claims, or may be learned by the practice of the disclosure as set forth hereinafter.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only exemplary embodiments of the disclosure and are not therefore to be considered to be limiting of its scope, the disclosure will be described and explained with additional specificity and detail through the use of the accompanying drawings in which:

FIG. 1 illustrates a schematic diagram of an exemplary green and environmentally friendly low-consumption power machine according to one embodiment of the present disclosure;

FIG. 2 depicts a side view of the power machine showing the arrangement of key components;

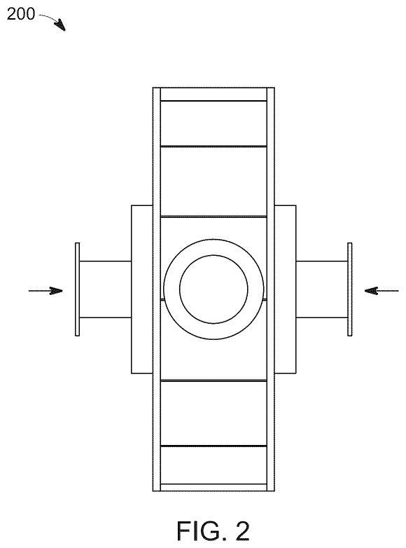

FIG. 3 shows a detailed view of the impeller assembly;

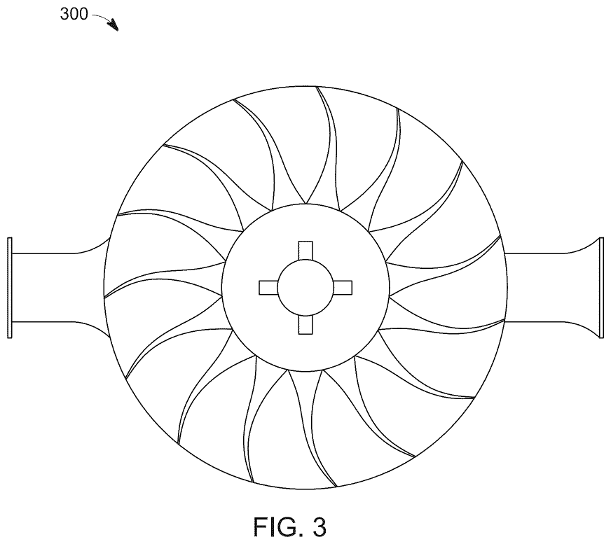

FIG. 4 presents a cross-sectional view of the primary water-air pressure tank.

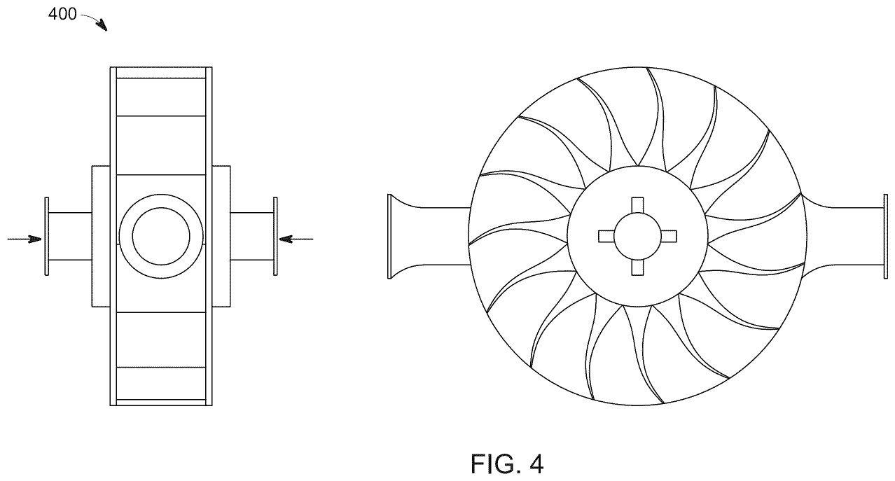

FIG. 5 illustrates a schematic diagram of the overall system layout.

FIG. 6 illustrates a detailed view of the Di compressor assembly, including several key components.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

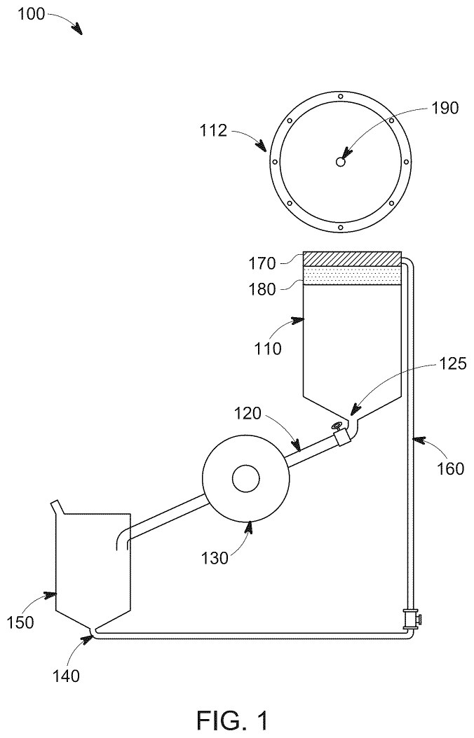

Referring to FIG. 1, a schematic diagram of an exemplary power machine 100 is illustrated. More specifically, FIG. 1 illustrates: 1.1 sealing cap; 1.2 vacuum machine; 1.3 energy reflux pore; 1.4 energy output port; 1.5 buoyancy sheet; 1.6 weight piece; 1. large energy storage tank; 2. debugging switch valve; 3. pipe; 4. stamping kinetic energy machine; 5. pipe; 6. small energy storage tank; 6.1 energy inlet; 6.2 air vent; 6.3 energy export; 7. energy reflux pipeline; 8. check valve. The power machine 100 includes a primary water-air pressure tank 110, an outlet pipe 120, an impeller 130, an adjustable size outlet valve 140, a secondary water-air pressure tank 150, and backwater pipes 160. The primary water-air pressure tank 110 serves as the main reservoir for water and pressurized air. It may be constructed of materials capable of withstanding high pressure, such as reinforced steel or composite materials. The tank 110 may include inlets for water and air, as well as outlets for pressurized water flow. The outlet pipe 120 connects the primary tank 110 to the impeller 130. It may be designed to handle high-pressure water flow and may include pressure-resistant materials and reinforced joints.

Furthermore, the impeller 130 is a key component of the power machine 100. It may be specially designed to efficiently convert the kinetic energy of the pressurized water into rotational mechanical energy. The impeller 130 may include multiple blades or vanes optimized for maximum energy conversion. The adjustable size outlet valve 140 controls the water flow rate to the impeller 130. It may be a precision-engineered valve capable of fine-tuning the water flow to optimize impeller performance. The valve 140 may be manually adjustable or electronically controlled for automated operation. Moreover, the secondary water-air pressure tank 150 may be used for pressure regulation or as a buffer in the system. It may have similar construction to the primary tank 110 but may be smaller in size. The backwater pipes 160 allow water recirculation back to the primary tank 110. They may be designed to handle the return flow of water efficiently and may include features to minimize energy loss during recirculation.

In operation, water is added to the primary water-air pressure tank 110 to a predetermined level. The backwater pipes 160 are connected to the primary tank 110 to stop water outflow. The primary tank 110 is then sealed to create an airtight environment. Pressurized air is added to the primary tank 110, creating a high-pressure water-air mixture. This high-pressure mixture flows through the outlet pipe 120 and the adjustable size outlet valve 140 to the impeller 130. The high-pressure water flow drives the impeller 130 to rotate at high speed. This rotational energy may be used to drive a generator (not shown) to produce electrical power. The water, after passing through the impeller 130, is collected and returned to the primary tank 110 via the backwater pipes 160.

Furthermore, the secondary water-air pressure tank 150 may be used to help regulate system pressure and ensure smooth operation. It may also serve as a buffer to accommodate fluctuations in water volume during operation. The adjustable size outlet valve 140 allows for fine-tuning of the water flow rate to optimize impeller performance. This adjustability may allow the system to adapt to varying power demands or operating conditions. The closed-loop nature of the system allows for continuous operation with minimal water consumption. The water is reused in each cycle, making the system highly efficient and environmentally friendly.

In some embodiments, the power machine 100 may include additional components such as pressure sensors, relief valves, and control systems to monitor and regulate system operation. These components may enhance safety, efficiency, and ease of use. The power machine 100 may be scalable, with the size and capacity of components adjustable to meet different power generation needs. It may be suitable for applications ranging from small-scale residential use to larger commercial or industrial installations. The green and environmentally friendly aspects of the power machine 100 stem from its closed-loop design, which minimizes resource consumption, and its ability to generate power without burning fossil fuels or producing harmful emissions.

The large energy storage tank 110 plays a crucial role in the operation of the power machine 100. It is designed to store a substantial volume of water and utilize the force of gravity to generate pressure within the system. The tank 110 is typically constructed from durable, pressure-resistant materials such as reinforced steel or high-strength composites to withstand the internal pressures generated during operation.

The large energy storage tank 110 includes a sealed cover 112 that is secured to the top of the tank using a sealing ring and screws. This sealed configuration is essential for creating and maintaining a vacuum within the upper portion of the tank during operation. The cover 112 may be equipped with a vacuum port to which the vacuum machine 190 can be attached.

Inside the large energy storage tank 110, a buoyancy ring 180 is installed. This ring 180 is designed to float on the water surface and provides a platform for the gravity steel plate 170. The gravity steel plate 170 is placed on top of the buoyancy ring 180, combining to exert a downward pressure on the water within the tank. This arrangement enhances the gravitational effect on the water, increasing the pressure generated as water flows downward through the system.

The bottom of the large energy storage tank 110 is equipped with an outlet 116 connected to the outlet pipe 120. This connection allows the pressurized water to flow from the tank 110 to the adjustable size outlet valve 140 and subsequently to the impeller 130. The high pressure generated by the gravitational force and the sealed environment of the tank 110 significantly increases the kinetic energy of the water as it reaches the impeller 130.

At the top of the large energy storage tank 110, there is a water return interface 118 connected to the backwater pipes 160. This interface allows water from the secondary water-air pressure tank 150 to be recirculated back into the large energy storage tank 110, completing the closed-loop system.

The vacuum machine 190 mounted on the cover 112 of the large energy storage tank 110 serves a critical function in maintaining system efficiency. As water flows downward and out of the tank 110, a vacuum is created in the upper portion of the tank. This vacuum generates a suction force that aids in drawing water back into the tank 110 through the backwater pipes 160. When the vacuum within the tank 110 diminishes over time or due to operational factors, the vacuum machine 190 activates to extract air from within the tank, thereby restoring and maintaining the vacuum condition.

The adjustable size outlet valve 140 is positioned between the outlet pipe 120 and the impeller 130. This valve 140 allows for precise control of the water flow rate from the large energy storage tank 110 to the impeller 130. By adjusting this valve, the operator can optimize the system's performance based on various factors such as desired power output or varying water levels in the tank.

The impeller 130 is a key component of the power machine 100. It may be specially designed to efficiently convert the kinetic energy of the pressurized water flow into rotational mechanical energy. It comprises a series of curved blades mounted on a central shaft. As the high-pressure water from the primary water-air pressure tank 110 flows through the outlet pipe 120 and past the adjustable size outlet valve 125, it impinges upon the curved blades of the impeller 130. This causes the impeller to rotate rapidly about its central axis.

The impeller 130 is typically made of a durable, corrosion-resistant material such as stainless steel or a high-strength polymer to withstand the continuous flow of water and potential debris. The number, size, and curvature of the blades are optimized to maximize energy conversion efficiency based on the expected water flow rate and pressure.

The central shaft of the impeller 130 is connected to power generation equipment (not shown), such as an electrical generator. As the impeller rotates, it drives the generator, converting the rotational mechanical energy into electrical energy. The speed of rotation, and consequently the power output, can be controlled by adjusting the water flow rate using the adjustable size outlet valve 125.

To ensure smooth and efficient operation, the impeller 130 is housed within a specially designed casing. This casing directs the water flow optimally onto the impeller blades and helps to minimize energy losses due to turbulence or backflow. The casing also includes seals to prevent water leakage around the impeller shaft.

After passing through the impeller 130, the water, now at a lower pressure, is directed towards the secondary water-air pressure tank 140 via connecting pipes. This arrangement allows for the continuous circulation of water through the system, maintaining the power generation cycle.

The impeller 130 is a critical component in this green and environmentally friendly low-consumption power machine, as it is the primary means by which the potential energy of the pressurized water is converted into usable mechanical and electrical energy. Its design and integration into the overall system play a crucial role in determining the efficiency and output of the entire power generation apparatus.

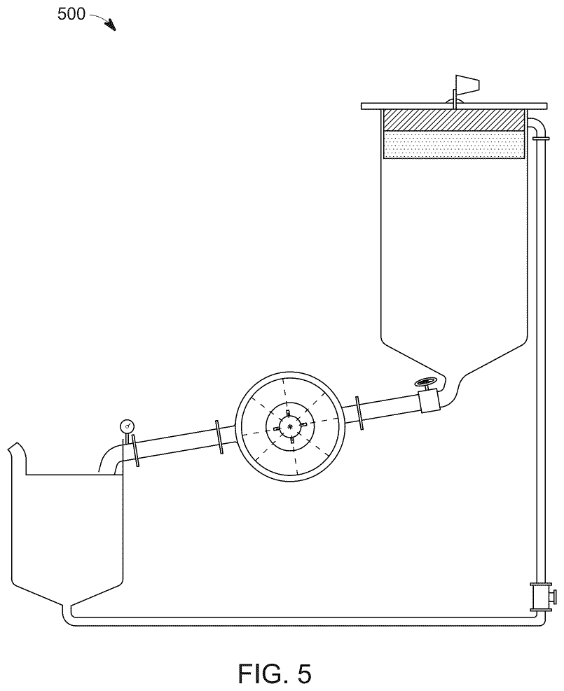

FIG. 5 illustrates a schematic diagram of the overall system layout, showing the interconnections between major components including the large energy storage tank, pipelines, shaft-driven impeller, adjustable test switch valve, small energy storage tank, and other key elements. Furthermore, FIG. 5 illustrates a schematic diagram of the overall system layout, showing the interconnections between major components including the large energy storage tank, pipelines, shaft-driven impeller, adjustable test switch valve, small energy storage tank, and other key elements. The large energy storage tank is depicted on the right side of the diagram, with an outlet at its bottom connecting to a pipeline. This pipeline leads to the shaft-driven impeller, which is represented by a circular component in the center of the diagram. The adjustable test switch valve is shown along this pipeline, allowing for flow control.

In one or more embodiments, the impeller is connected via another pipeline to the small energy storage tank, shown on the left side of the diagram. A return pipeline system is illustrated, connecting the small tank back to the top of the large energy storage tank, completing the closed-loop circulation. Various other components such as valves and connection points are also depicted throughout the system. The diagram includes labels in a non-English language, likely Chinese, identifying each component. These labels correspond to a numbered list on the left side of the figure, providing a key to the different parts of the system. This schematic provides a comprehensive overview of how the various elements of the power machine are interconnected and how water may flow through the system during operation.

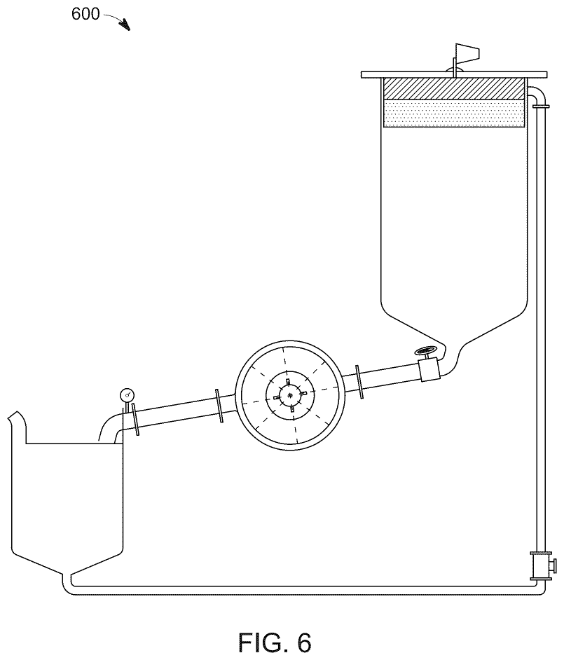

FIG. 6 depicts a detailed view of the Di compressor assembly, including several key components:
1. Steel sheet (gravity steel sheet): This is shown at the top of the assembly, likely providing weight or pressure to the system.
2. Effluent path: A pathway for water or fluid outflow is indicated.
3. On-off valve: This valve is depicted, allowing for control of fluid flow.
4. Pipe configured as turbo machinery: The main pipe is labeled as being configured for turbo machinery, suggesting it plays a role in energy generation.
5. Energy storage tank: This large component is central to the assembly, likely storing water or compressed air.
6. Exhaust port: An outlet for exhaust or excess fluid is shown.
7. Return water outlet: This component allows for the recirculation of water in the system.

In one or more embodiments, the FIG. 6 also includes annotations indicating the installation of generators of various shapes and sizes, as well as the ability to dock with external turbines for power generation. This suggests that the Di compressor assembly is designed to be versatile and adaptable to different power generation setups. The overall layout of the figure provides a cross-sectional view of the assembly, showing how these components are arranged and interconnected within the system. This detailed representation helps to illustrate the functional relationships between the different parts of the Di compressor and how they contribute to the overall power generation process.

In one or more embodiments, the power machine 100 may be designed to operate in a continuous cycle, minimizing water consumption and environmental impact. The closed-loop system allows for efficient use of resources, as the water is continuously recirculated and reused. This design may make the power machine 100 suitable for various applications where sustainable and low-impact power generation is desired. Safety features may be incorporated into the power machine 100 to ensure reliable operation. These may include pressure relief valves on the tanks, emergency shut-off mechanisms, and sensors to monitor system parameters such as pressure, temperature, and water levels. These safety features may help prevent overpressurization and other potential hazards.

In one or more embodiments, the power machine 100 may be scalable, allowing for customization to meet different power generation needs. Smaller versions may be suitable for residential or small commercial applications, while larger systems may be designed for industrial use or even large-scale power generation. The basic principles of operation may remain the same across different scales, with component sizes and capacities adjusted accordingly.

Moreover, in some embodiments, the power machine 100 may be integrated with renewable energy sources such as solar or wind power. For example, excess energy from solar panels or wind turbines may be used to pressurize the primary water-air pressure tank 110, enhancing the overall efficiency and sustainability of the power generation system. In one or more embodiments, the power machine 100 may also incorporate advanced control systems and monitoring technologies. These may include computerized control interfaces, remote monitoring capabilities, and predictive maintenance algorithms. Such features may enhance the ease of operation, improve efficiency, and reduce downtime.

While the power machine 100 has been described with reference to certain embodiments, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular embodiment disclosed, but that the disclosure will include all embodiments falling within the scope of the appended claims. While specific embodiments have been described above, it will be appreciated that the disclosure may be practiced otherwise than as described. The descriptions above are intended to be illustrative, not limiting. Thus, it will be apparent to one skilled in the art that modifications may be made to the disclosure as described without departing from the scope of the claims set out below.

What is claimed is:

1. A green and environmentally friendly low-consumption power machine comprising:
a primary water-air pressure tank;
an outlet pipe connected to the primary water-air pressure tank;
an impeller fluidly connected to the outlet pipe;
an adjustable size outlet valve positioned between the outlet pipe and the impeller;
a secondary water-air pressure tank; and
backwater pipes connected between the impeller and the primary water-air pressure tank.

2. The power machine of claim 1, wherein the primary water-air pressure tank is configured to contain a mixture of water and pressurized air.

3. The power machine of claim 1, wherein the impeller is configured to convert kinetic energy of pressurized water flow into rotational mechanical energy.

4. The power machine of claim 1, wherein the adjustable size outlet valve is configured to control a water flow rate to the impeller.

5. The power machine of claim 1, wherein the secondary water-air pressure tank is configured to regulate system pressure.

6. The power machine of claim 1, wherein the backwater pipes are configured to recirculate water from the impeller back to the primary water-air pressure tank.

7. The power machine of claim 1, further comprising a sealing mechanism for the primary water-air pressure tank.

8. The power machine of claim 1, further comprising an air pressurization system configured to add pressurized air to the primary water-air pressure tank.

9. The power machine of claim 1, further comprising a power generation equipment coupled to the impeller.

10. A method of operating a green and environmentally friendly low-consumption power machine, the method comprising:
adding water to a primary water-air pressure tank;
connecting backwater pipes to the primary water-air pressure tank to stop water outflow;
sealing the primary water-air pressure tank;
adding air pressure to the primary water-air pressure tank;
allowing pressurized water to flow through an outlet pipe to an impeller;
driving the impeller with the pressurized water flow; and
recirculating water from the impeller back to the primary water-air pressure tank via the backwater pipes.

11. The method of claim 10, further comprising adjusting a water flow rate to the impeller using an adjustable size outlet valve.

12. The method of claim 10, further comprising regulating system pressure using a secondary water-air pressure tank.

13. The method of claim 10, further comprising generating electrical power using the rotational energy of the impeller.

14. The method of claim 10, further comprising monitoring system pressure using one or more pressure sensors.

15. A closed-loop power generation system comprising:
a primary pressurized tank configured to contain a mixture of water and pressurized air;
a water flow path from the primary pressurized tank to an energy conversion device;
a flow control mechanism in the water flow path;
an energy conversion device configured to convert kinetic energy of pressurized water flow into another form of energy; and
a water return path from the energy conversion device back to the primary pressurized tank.

16. The system of claim 15, wherein the energy conversion device comprises an impeller.

17. The system of claim 15, wherein the flow control mechanism comprises an adjustable valve.

18. The system of claim 15, further comprising a secondary pressurized tank configured to regulate system pressure.

19. The system of claim 15, further comprising a sealing mechanism for the primary pressurized tank.

20. The system of claim 15, further comprising an air pressurization system configured to add pressurized air to the primary pressurized tank.
